(19) United States
(12) Patent Application Publication
(10) Pub. No.: US 2006/0284004 A1
(43) Pub. Date: Dec. 21, 2006

(54) Method of scavenging atmospheric energy, causing rainfall, and for dissipating severe weather formations using an electrostatic dirigible

(76) Inventor: Edward B. Jones, Pelham, NC (US)

Correspondence Address: Royal W. Craig;Ober, Kaler, Grimes & Shriver, 120 East Baltimore Street, Baltimore, MD, 21202-1643, US

(21) Appl. No.: 11/453,274

(22) Filed: Jun. 14, 2006

Related U.S. Application Data
(60) Provisional application No. 60/690,422, filed on Jun. 14, 2005.

(51) Int. Cl. A01G 15/00; B64B 1/50

(52) U.S. Cl. 244/33; 239/2.1

(57) ABSTRACT

A method and apparatus for scavenging atmospheric energy, causing rainfall, and for dissipating severe weather formations using a lighter-than-air dirigible or balloon suspended by two controlled tethers wound on motorized spools, the tethers being electrically connected to a high-voltage electrostatic generator on the ground. The dirigible is suspended by the tethers at cloud height which is adjustable by the spools. The dirigible includes a conductive foil skin suitable for carrying a conductive charge. To produce rainfall, the dirigible is charged by the electrostatic generator through the tethers at a voltage that is high enough to attract ions of water vapor. To produce energy, the dirigible scavenges charge from upper cloud layer positive ions and distributes the charge down through tethers where it can be collected and used for motive power or to charge batteries. To avert severe weather, the dirigible equalizes the negatively charged earth with the upper cloud layer positive ions, thereby eliminating the charge of the severe weather system.

### CROSS-REFERENCE TO RELATED APPLICATION(S)

The present application derives priority from U.S. Provisional Application No. U.S. patent application Ser. No. 60/690,422 filed Jun. 14, 2005.

### BACKGROUND OF THE INVENTION

1. Field of Invention

The present invention relates to power generation and weather control by atmospheric estabilization and, more particularly, to an improved method and apparatus for scavenging atmospheric energy, causing rainfall, and for dissipating severe weather formations using an electrostatic dirigible.

2. Description of the Prior Art

People have long attempted to control their environment to take advantage of nature's energy sources or to control weather, pollution, etc. Generally, these environmental controls seek to subdue severe weather, cause rainfall at will, or scavenging natural energy to reduce reliance on depletable fuel supplies, in all such cases utilizing nature's ecological cycles to meet mankind's needs. To the best of the present inventor's knowledge, there have been no prior efforts to scavenge the energy of atmospheric water vapor, or to de-stabilize atmospheric conditions to avert severe weather or cause rainfall at will. Others have tried to de-stabilize the atmospheric inversion layer using balloons.

For example, U.S. Pat. No. 3,974,756 to Long issued Aug. 17, 1976 teaches an apparatus and method for field burning and fog or smog control that utilizes a long, segmented, high altitude flue of flexible light-weight material, suspended vertically by a gas-filled balloon. The flue tapers upwards from an extremely large bottom opening through which the smoke enters. The stack is adjustable in height and is made of fireproof material. A rigid wall enclosure elevated above the ground level and refire grids of refractory materials are used to minimize the escape of combustible materials. Cables connects both the enclosure and balloon, and are held by winch equipped ground vehicles.

U.S. Pat. No. 5,295,625 to Redford issued Mar. 22, 1994 teaches a cylindrical apparatus suspended in the atmosphere that continuously promotes convective air movement inside it, as a way to gather, transport and distribute condensed water from the water vapor present in the air moving inside. This water can be dispersed as a controlled rain for micro climate control purposes.

Both of these devices are rather complex and single-purpose. It would be greatly advantageous to provide an improved multi-purpose method and apparatus for scavenging atmospheric energy, creating rain, and for dissipating severe weather formations using an electrostatically-charged dirigible.

### SUMMARY OF THE INVENTION

It is, therefore, an object of the present invention to provide an electrostatic dirigible, tethered support system, and ground-based generator that places an electrostatic charge on the dirigible in order to scavenge atmospheric energy, create rain, and dissipate severe weather formations.

In accordance with the above objects, an improved method and apparatus for scavenging atmospheric energy, causing rainfall, and for dissipating severe weather formations is disclosed that generally employs a lighter-than-air dirigible or balloon suspended by two controlled tethers wound on motorized spools, the tethers being electrically connected to a high-voltage electrostatic generator on the ground. The dirigible is suspended by the tethers at cloud height which is adjustable by the spools, and the tethers keep the dirigible in a fixed but adjustable location despite shifting winds. The dirigible includes a conductive foil skin suitable for carrying a conductive charge. To produce rainfall, the dirigible is charged by the electrostatic generator through the tethers at a voltage that is high enough to attract ions of water vapor. To produce energy, the dirigible scavenges charge from upper cloud layer positive ions and distributes the charge down through tethers where it can be collected and used for motive power or to charge batteries. To avert severe weather, the dirigible equalizes the negatively charged earth below, with the upper cloud layer positive ions, thereby eliminating the charge of the severe weather system. The system is effective and efficient, and has many applications and advantages.

### BRIEF DESCRIPTION OF THE DRAWINGS

FIG. 1 is a system diagram of the method and apparatus for scavenging atmospheric energy and for dissipating severe weather formations using an electrostatic dirigible according to a preferred embodiment of the present invention.

FIG. 2 illustrates a suitable generator 8 configuration for this purpose.

### DETAILED DESCRIPTION OF THE PREFERRED EMBODIMENT

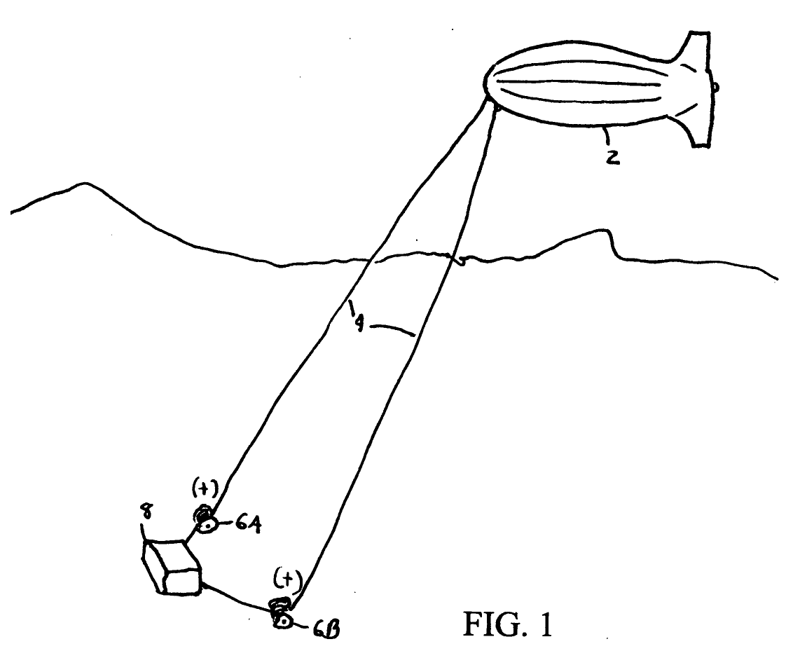

FIG. 1 is a system diagram of the method and apparatus for scavenging atmospheric energy and for dissipating severe weather formations using an electrostatic dirigible according o a preferred embodiment of the present invention. The system is capable of producing rain on demand, power to replace fossil fuel and nuclear sources, and dissipating severe weather conditions such as storms, hurricanes and tornados. The system generally comprises a lighter-than-air dirigible or balloon 2 suspended by two controlled tethers 4 wound on motorized spools 6A & 6B. The tethers 4 and spools 6A & 6B are electrically connected to a high-voltage electrostatic generator 8. The dirigible 2 is suspended by tethers 4 at cloud height (the height may be adjusted by spools 6A & 6B), and the tethers 4 keep the dirigible in a fixed but adjustable location despite shifting winds. With a single tether the dirigible 2 would not remain in the same location despite changing wind conditions. However, the dual tethers 4 with angular separation do serve to maintain a fixed (though adjustable) position of the dirigible 2 despite winds. The dirigible 2 preferably comprises an outer layer of metallic paint, or conductive foil skin such as Mylar, that is suitable for carrying a conductive charge.

To produce rainfall, the dirigible 2 is charged by electrostatic generator 8 through the tethers 4 at a voltage that is high enough to attract ions of water vapor (OH)—. The electrostatic charge on dirigible 2 works by the following equations to attract negative ions and repel positive ions.

Cathode reaction: 4(OH)——4e (electrons)>2H2O (rain)+O2

Anode reaction: 2H2O+O2+4H+>4H2O

The 4H+ ions were repelled from the dirigible 2.

The amount of power required to charge the dirigible 2 by electrostatic generator 8 can be calculated in a known manner from a known quantity of water falling from a given height. For example, if a rainfall of 200 gallons per minute is desired and we know that the rain will fall from 5000 feet, we can calculate the force of the rain and the force needed to drive the generator 8 as follows:

1 h.p./550 ft-lbs/sec×7.5 lbs/1 gal×1 min/60 secs×200 gals/1 min×5000 feet=227 horsepower.

This power is also the product of voltage on the dirigible 2 times the ionization factor of the atmosphere. A higher voltage or ionization factor will produce more rainfall, and a lower voltage or ionization factor will produce less rainfall. This means that 200 gallons per minute will be produced by 227 horsepower under any conditions. If conditions are ready to produce rain anyway, the voltage on the dirigible 2 need not be great. On the other hand, in a very dry atmosphere (such as over a desert) the voltage on the dirigible 2 must be raised significantly. If it is too dry to produce 200 gallons/minute, the power input will be proportional.

To produce energy, the dirigible 2 scavenges charge from upper cloud layer positive ions H+, and distributes the charge down through tethers 4 where it can be collected and used for motive power or to charge batteries.

To avert severe weather, the dirigible 2 equalizes the negatively charged ions of earth below with the upper cloud layer positive ions H+, thereby eliminating the charge of the severe weather system. With all storms, the earth below receives a negative charge and the cloud layer a positive charge. As the wind blows the clouds along, the negative charge on the earth moves along underneath. It does not remain in the same location, but rather the greater negative charge of the earth follows the positive charge of the cloud layer above.

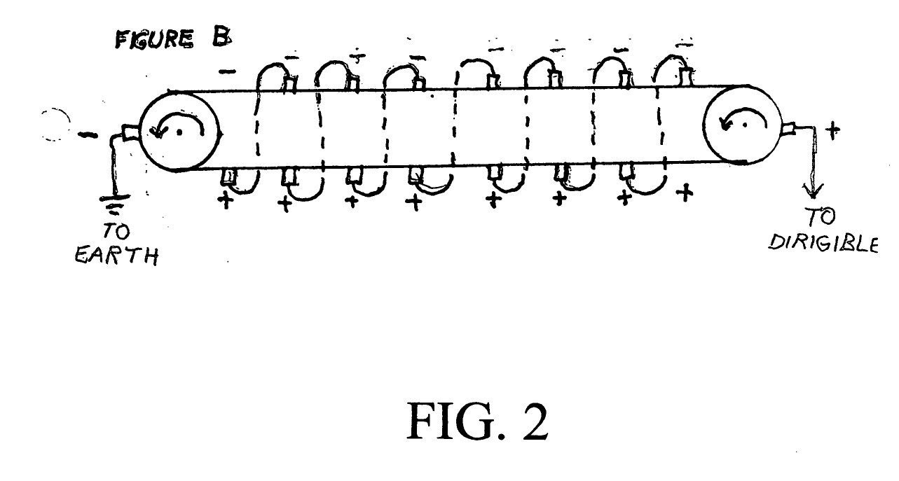

FIG. 2 illustrates a suitable generator 8 configuration for this purpose, which is partially based on the principal set forth in U.S. Pat. No. 6,771,002 by the named inventor herein. Specifically, the generator 8 comprises a rotating belt carried on opposing pulleys, and a plurality of brushes maintained in facing contact with the opposing sides of the belt. All brushes along one side (top) of the belt are designed negative, and all brushes along the other side (bottom) of the belt are designed positive. The positive brushes are connected in a daisy-chain manner (as shown) to the negative brushes. This way, assuming that the belt rotates counterclockwise as shown, each negative brush deposits static negative charge to the belt, leaving the trailing part of the belt more negative. Similarly, each positive brush collects static positive charge from the belt, leaving the trailing part of the belt more positive. Given the connection of the brushes as shown, the result is a very high ladder charge accumulated at the ends of the belt, and the (+) end of the belt can be coupled to the (+) coils 6A & 6B in FIG. 1 for use of the ladder charge that is high enough to attract ions of water vapor (OH)—. Preferably, a manual safety switch is provided proximate the generator 8 to short the dirigible to ground. This serves in case of emergency or problems to cancel the charge in the clouds and earth.

The above-described system is effective and efficient, and has many applications and advantages in scavenging atmospheric energy, creating rain, and for dissipating severe weather formations. For example, firemen and farmers will benefit by planned rainfalls, public reliance on fossil and nuclear fuels will be reduced, and damaging storms will be averted.

Having now filly set forth the preferred embodiments and certain modifications of the concept underlying the present invention, various other embodiments as well as certain variations and modifications of the embodiments herein shown and described will obviously occur to those skilled in the art upon becoming familiar with said underlying concept. For example, a plurality of the above-described dirigibles 2 may be suspended at strategic points such as along a coastline to avert incoming hurricanes. It is to be understood, therefore, that the invention may be practiced otherwise than as specifically claimed herein.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims:

I claim:

1. A system for scavenging atmospheric energy, causing rainfall, and for dissipating severe weather formations, comprising:
a lighter-than-air dirigible having a conductive skin;
a ground-based electrostatic generator;
two tethers for suspending the dirigible at a controlled height, said tethers being conductive and connected to said generator;
two motorized spools for adjustably spooling the tethers at a controlled height approximating cloud height;
whereby said system can produce rainfall by charging the dirigible by the electrostatic generator at a voltage to attract ions of water vapor, and can produce energy by scavenging charge from upper cloud layer positive ions, and can avert severe weather by equalizing the negatively charged earth with upper cloud layer positive ions, thereby eliminating the charge of the severe weather system.

2. The system for scavenging atmospheric energy according to claim 1, wherein said lighter-than-air dirigible conductive skin comprises Mylar™.

3. The system for scavenging atmospheric energy according to claim 1, wherein said ground-based electrostatic generator comprises a rotating belt for generating a ladder charge.

4. A method for scavenging atmospheric energy, comprising the steps of:
elevating a lighter-than-air dirigible having a conductive skin to cloud level using a pair of conductive tethers wound on motorized spools;
connecting said spools to a high-voltage electrostatic generator;
powering said generator to charge the dirigible at a voltage to attract ions of water vapor, thereby averting severe weather by equalizing negatively charged earth with upper cloud layer positive ions.
